(19) United States
(12) Patent Application Publication
(10) Pub. No.: US 2019/0146450 A1
(43) Pub. Date: May 16, 2019

(54) PROGRAMMABLE LOGIC CONTROLLER WITH MANAGEMENT SYSTEM

(71) Applicant: ABB Schweiz AG, Baden (CH)

(72) Inventors: Stephan Sehestedt, Mannheim (DE); Stefan Hauck-Stattelmann, St.Leon-Rot (DE); Jeffrey Harding, Holly Springs, NC (US); Heiko Koziolek, Karlsruhe (DE)

(21) Appl. No.: 16/249,943

(22) Filed: Jan. 17, 2019

Related U.S. Application Data
(63) Continuation of application No. PCT/EP2017/068270, filed on Jul. 19, 2017.

(30) Foreign Application Priority Data
Jul. 19, 2016 (EP) 16180149.3

(51) Int. Cl. G05B 19/05

(52) U.S. Cl. CPC G05B 19/056; G05B 2219/13004; G05B 2219/1204

(57) ABSTRACT

A programmable logic controller for at least one field device in an industrial facility includes: a hardware platform on which an operating system runs, the operating system executing, in at least one process, at least one execution environment in which a control software containing the control logic of the programmable logic controller is runnable, the hardware platform including a main memory, a processor power, and communication resources; and a higher-level management system for running directly on the operating system and executing one or more execution environments in each case in its own sandbox, the management system including a resource manager for allocating to each sandbox access to the main memory, the processor power, and the communication resources of the hardware platform.

### CROSS-REFERENCE TO PRIOR APPLICATION

This application is a continuation of International Patent Application No. PCT/EP2017/068270, filed on Jul. 19, 2017, which claims priority to European Patent Application No. EP 16180149.3, filed on Jul. 19, 2016. The entire disclosure of both applications is hereby incorporated by reference herein.

### FIELD

The invention relates to programmable logic controllers for controlling field devices in distributed control systems for industrial facilities.

### BACKGROUND

Many industrial facilities are controlled by distributed control systems (DCS). Basic components of such control systems are programmable logic controllers (PLC).

A common PLC comprises a hardware platform and control software precisely adapted to this hardware platform. The control software is executed on the hardware in an execution environment programmed at a low level. Via communication resources of the hardware platform, the PLC is connected, horizontally, to other PLC's and, vertically, to controlled field devices as well as higher-level control systems.

The control software is typically specific to a particular hardware platform and the execution environment running on it. The control software must therefore be adapted when the PLC changes. This may even be required if the control software was programmed according to a standard (e.g., IEC 61131-3) and both the old and the new PLC support this standard, since current standards do not necessarily bindingly specify all details of the execution behavior.

If, for example, the industrial facility is now expanded by a new system component which has the same functionality as an existing system component, the new system component must also be included in the control system. When the specification in this case is that the custom control software is to remain untouched, replacing existing PLC's by more powerful ones is possible to only a very limited extent, due to the tight connection of the control software to the PLC. Often, the expansion has to take place with additional PLC's of the same type. Retrofitting new functions is also only possible with difficulty. The installation of additional PLC's into an existing control system can in turn fail due to lack of space in existing switch cabinets.

It is known from EP 2 506 098 A1 to execute the control software within the PLC on a virtual machine, so that one and the same control software can be executed on different types of PLC's. Several of these virtual machines can be executed concurrently on one and the same PLC. WO 2015/124 320 A1 discloses another dynamic PLC on which several different control programs can be executed concurrently. Thus, additional functionality can be imparted to a PLC by adding another control program.

With long-term productive use of such solutions, there is basically the difficulty that the trouble-free execution of a control program also depends upon the good behavior of the other concurrently running control programs.

### SUMMARY

In an embodiment, the present invention provides a programmable logic controller for at least one field device in an industrial facility, comprising: a hardware platform on which an operating system runs, the operating system being configured to execute, in at least one process, at least one execution environment in which a control software containing the control logic of the programmable logic controller is runnable, the hardware platform comprising a main memory, a processor power, and communication resources; and a higher-level management system configured to run directly on the operating system and to execute one or more execution environments in each case in its own sandbox, the management system comprising a resource manager configured to allocate to each sandbox access to the main memory, the processor power, and the communication resources of the hardware platform.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1: Industrial facility 100 with PLC 1 according to a first exemplary embodiment with virtual machines 81, 82, 83.

FIG. 2: Industrial facility 100 with PLC 1 according to a second exemplary embodiment with abstraction layers 71, 72, 73.

FIG. 3: For comparison, PLC 102 according to the prior art.

### DETAILED DESCRIPTION

It is therefore the aim of the invention to improve the scalability of a single PLC and of the control system as a whole by additional functionality.

This aim is achieved according to the invention by a programmable logic controller described herein and by an associated computer program product.

Within the framework of the invention, a programmable logic controller (PLC) for at least one field device in an industrial facility was developed. This PLC comprises an operating system which is in turn designed to execute, in at least one process, at least one execution environment in which a control software containing the control logic of the programmable logic controller can be run.

According to the invention, a higher-level management system is additionally provided. This management system is designed to run directly on the operating system and to execute one or more execution environments in each case in its own sandbox. The management system comprises a resource manager designed to allocate to each sandbox the access to the main memory, processor power, and communication resources of the hardware platform.

The resource manager has the effect that the trouble-free execution of an instance of the control software now no longer depends upon the good behavior of other, concurrently running control programs. Instead, the control software has schedulable resources, as if it were running on a correspondingly dimensioned hardware platform alone. The resource manager thus completes the independence of the sandboxes from each other, and the protection of the sandboxes against mutual interference.

The operating system of the PLC can, in particular, be a real-time-capable operating system. The resource manager then has the effect that a guarantee for response times can be given, even though multiple instances of the control software run concurrently.

By means of the resource manager, an existing PLC can, in several respects, be expanded additively, i.e., without impairing the existing functionality.

On the one hand, the control functionality of the PLC can be expanded with a further instance of the existing control software to other similar field devices, e.g., when the industrial facility is expanded by a new, functionally identical system component. The performance of the hardware platform of PLC's is generally dimensioned for a specific complexity of the control software, also generously taking into account the fact that a later retrofitting of the hardware is usually not possible. Thus, in many industrial facilities, the hardware of the PLC is oversized for the performance actually required by the control software. The invention thus makes it possible to use such free capacities. Instead of acquiring further PLC's, the dead capital bound in the existing hardware may thus first be activated.

On the other hand, completely new functions can also be added to the PLC with significantly less effort. So far, this has been difficult even if “only” the new functions were to be entered into the control software, without changing the hardware. Any change may invalidate a validation or similar testing of the control software overall, similarly to breaking a seal of warranty when opening a device housing. The test must be re-taken, with corresponding effort. This is also not unjustified, because many cases are known in software technology in which an intentional improvement at one point surprisingly led to an impairment of the functionality at another point. The more complex the control software is, the more difficult it is to have an overview of such interactions. On the other hand, if the additional functionality is offloaded to a further instance of the control software, sandboxing the instances with respect to each other ensures that the existing functionality is not impaired. Only the newly-added program code must thus be tested.

Furthermore, this also avoids the difficulty that monolithic control software cannot grow arbitrarily, because the architecture of the hardware platforms for PLC's typically limits the complexity of the software executable thereon. For instance, a limit on the maximum allowable program size can be circumvented by the separation into two instances.

Lastly, thanks to the management system, production lines within the meaning of “industry 4.0” can be designed flexibly. Since it can now be determined via the management system which control software runs on the PLC in detail, the PLC may be reconfigured overall at runtime to an entirely different function, and to control completely different field devices than originally planned. According to the prior art, this would require additional PLC's, as well as a possibility of switching between PLC's, for which a solution cannot be currently bought on the market.

It is thus advantageous to already provide, at the factory, a new PLC with the management system, even if a parallel execution of multiple instances of the control software is not yet intended. However, the management system can also be retrofitted subsequently in the form of software, and is thus a product that can be sold independently.

The allocation of the resources can, for example, be statically determined when setting up (engineering) the PLC. For a manual determination, the user can, for example, use his experience, or also test results. The allocation can, however, also be determined and/or dynamically adjusted during, for example, the initialization at system start-up or later, during the runtime of the PLC. Static or dynamic analyses of the control software, which provide information about the resource requirements, can also be used for the allocation.

All means which the operating system and/or the hardware platform provide for this purpose can be used for the partitioning (sandboxing) of the sandboxes from one another. For example, a memory management unit (MMU) of the hardware platform can partition the areas of the main memory allocated to the individual sandboxes from one another. Furthermore, the functions of the operating system may be used for partitioning the processes from one another, such as the concept that each process only has access to itself and its subprocesses. Lastly, functions of the operating system for monitoring and enforcing resource allocation, such as the “ulimits” of Unix-like operating systems or software containers, can also be used.

In a particularly advantageous embodiment of the invention, the management system has a redundancy manager designed to retrieve and provide the functionality of the controller, provided in relation to the field device, from multiple redundant instances of the control software. In this way, a redundancy can be retrofitted as a pure software solution, without changing the existing control software. This also applies when redundancy was not considered at all in the development of the original control software.

However, the redundancy manager need not necessarily be implemented purely in software. The redundancy manager, as well as other parts of the management system, may also be entirely or partially implemented in hardware. This may, for example, increase the performance at the cost of the management system becoming harder to port to other hardware platforms.

The integration of the redundancy manager into the management system makes it, in particular, possible to individually determine the redundancy level for each execution environment and each instance of the control software in the initial setup (engineering) of the PLC or at runtime via a configuration interface of the PLC, independently of whether a possible provision of redundancy is implemented in the actual configuration routine of the control software.

By providing redundancy, a required safety integrity level (SIL) can be achieved with less effort, for example. For example, SIL3 can be achieved by combining a first sandbox with SIL1-compliant software and a second sandbox with SIL2-compliant software.

For example, the redundancy manager can advantageously be designed to send data inputs from the field device to multiple instances of the control software and to make the data outputs subsequently generated by these instances plausible with respect to each other. If, for example, two instances then supply data outputs that correspond at least roughly, while the output of a third instance deviates markedly therefrom, the third instance may, possibly, not work properly. For example, a single bit may be flipped in the portion of the main memory responsible for the third instance and may cause numerical values provided by the field device for a pressure to be interpreted in the unit, “pounds per square inch” (psi), instead of correctly in “bars.” The outputs generated by the third instance then systematically deviate from the outputs of the other two instances.

The redundancy manager may also advantageously be designed to continuously monitor the function of multiple instances of the control software and, when an instance fails or malfunctions, to restart this instance and/or its execution environment, and/or to activate at least one additional instance in an additional execution environment in a further sandbox. For example, a program error in the control software can lead to main memory that is reserved in certain situations not being released again (memory leak) after use, so that the available main memory is completely depleted at some time. A restart of the control software initiated by the redundancy manager then does not eliminate the cause of the problem, but the new sandbox again begins with a “clean” main memory, so that the problem is at least temporarily alleviated. In addition, the plant operator is made aware of the problem in this way and can get to the bottom of it, in terms of software technology.

The redundancy manager may, for example, also be advantageously designed to control the communication of multiple instances of the control software with the field device according to a round robin method. All instances are then utilized evenly. If a regularly addressed instance does not respond for a predetermined time interval (timeout), this instance can be recognized as not working properly.

In a further, particularly advantageous embodiment of the invention, two execution environments having different contents and/or two instances of the control software having different contents are provided, to afford one and the same functionality of the PLC. Operational reliability can thereby be further increased—in particular, in redundant operation. Behind this is the idea that it is unlikely that, for example, two instances of the control software programmed by different developers according to different concepts have errors that have the same effect in precisely the same operating situation.

However, multiple instances of the control software can also be executed concurrently, for example, in order to test a new version of the control software that is under development or newly acquired, without the ongoing operation of the previous version being interrupted, and the thus controlled industrial process having to be stopped for this purpose. Furthermore, when the functionality is expanded, an instance of the previous control software can be executed together with a further instance which contains only the additional added functions.

Lastly, it is, for example, also possible for control programs written for different types of PLC's to be consolidated in different execution environments on one and the same physical PLC, or on a server with corresponding communication interfaces, for example. The server can then have the same effect as the respectively emulated PLC. In principle, different execution environments for different customers, between which there is no trust relationship, can also be consolidated on one and the same server. The functionality of the management system for partitioning the sandboxes from one another can then, for example, also be expanded by safety functions for protection against intentional trespasses between sandboxes.

In a particularly advantageous embodiment of the invention, at least one sandbox contains an abstraction layer, which reacts to system calls originating from the execution environment in the same way as the operating system and/or the hardware of a control unit for which the execution environment and/or the associated control software was developed. For example, the system calls originating from the control software provided by the factory with the PLC can be abstracted by the operating system and/or by the hardware platform in this way, so that program code can be re-used on other hardware platforms to a greater extent. However, it is also possible, for example, to provide an environment in which a control software developed for a control unit of another, incompatible type is made executable on the PLC. In this way, existing control software can, for example, be migrated to a new PLC with a new hardware platform, without having to change the control software for this purpose.

Advantageously, the abstraction layer includes at least one runtime environment which implements handling routines for the system calls originating from the execution environment, using means provided by the operating system. Analogously to the runtime environment, “wine,” for example, with which Windows® programs are made executable in Unix-like operating systems, the execution environment and the associated control software can then run as a native process in the operating system of the PLC, without having to be virtualized by a hypervisor. Compared to a virtualization, this can save system resources of the hardware platform, which can instead be used in the execution of more instances of the control software.

In a further advantageous embodiment of the invention, the management system contains a hypervisor, which is designed to provide a separate virtual machine for each sandbox. This consumes more system resources, but is simpler to implement than a runtime environment that individually emulates the handling for each system call. Instead, the hardware platform may, for example, be emulated en bloc.

Advantageously, at least one version, adapted to the hypervisor, of an execution environment and/or at least one version, adapted to the hypervisor, of the abstraction layer is paravirtualized by the hypervisor. In this way, the hypervisor can be simplified, in that higher performance is available in the individual sandboxes.

In a further, particularly advantageous embodiment of the invention, the resource manager is designed to reallocate allocations unused in at least one first sandbox for access to the main memory, processor power, and/or communication resources to at least one second sandbox. This can take place, in particular, when the resources of the second sandbox are overloaded, or when this is imminent. In this way, the load level of the hardware platform can be improved. In particular, more functionality for controlling more field devices can be accommodated overall in a given switch cabinet volume. According to the prior art, lack of space in existing switch cabinets could be a noticeable obstacle to the expansion of the industrial control system. Furthermore, the specific energy consumption of the control system is lower when the hardware of the PLC is better utilized. The allocation may also be made dependent upon other parameters, such as priorities or heuristics.

In a further, particularly advantageous embodiment of the invention, the resource manager is designed to completely or partially revoke the respective resource of at least one first sandbox, and to reallocate it to at least one second sandbox according to rules in a set of rules when there is a shortage of main memory, processor power, and/or communication resources. This is based upon the idea that, if sufficient resources are no longer available for the normal operation of the PLC due to a hardware failure, the inevitable operating restrictions should at least be predictable, and their effects on the industrial facility should, ideally, be minimized. If, for example, a shutdown of the industrial facility cannot be avoided, a corresponding set of rules can, for example, ensure that the shutdown of the individual system components takes place in an order and manner that is gentle for the industrial facility overall. For example, in an evacuated system, the devices dependent upon the vacuum should be switched off first, and then the vacuum pump. Furthermore, it may be expedient to concentrate the efforts upon maintaining the vacuum and to switch off more devices at another point, if restoring the vacuum with bake-out lasts several days.

Many control systems according to the prior art still strove after a full restoration of the system operation in the case of a fault, even if this was no longer objectively possible with the still available resources. With the management system provided according to the invention, such a situation can be recognized, and the optimization goal can be changed to a gentle scaling down or shutting down of the operation (“graceful degradation”).

In a further, particularly advantageous embodiment of the invention, the rules in the set of rules are therefore staggered according to the effects of the respective revocation of resources on the industrial facility as a whole. For example, a complete standstill of the system may possibly be avoided by slowing non-time-critical processes. The regulation of these processes then requires less computing time, which can, instead, additionally be made available for the regulation of time-critical processes.

In light of the above, the management system can be retrofitted by software. The invention therefore also relates to a computer program product with machine-readable instructions, which, if executed on a computer and/or a programmable logic controller, upgrade the computer or programmable logic controller to a programmable logic controller according to the invention.

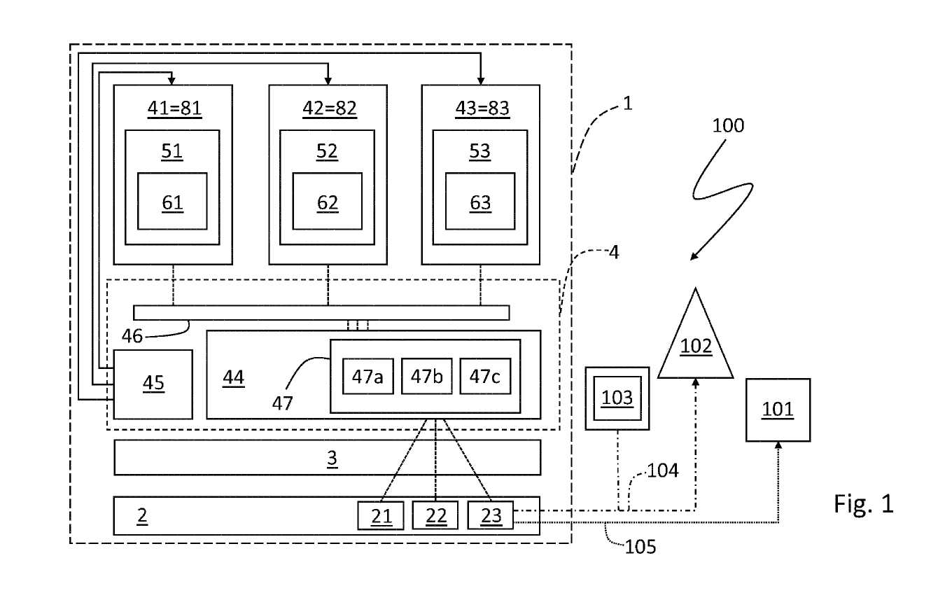

FIG. 1 shows by way of example an industrial facility 100, in which, by way of example, a field device 101 is controlled by a PLC 1 via an I/O interface 105. In addition, the PLC 1 is connected to a network 104, which additionally contains a PLC 102 according to the prior art, as well as a human-machine interface 103.

The PLC 1 contains a hardware platform 2, which provides the main memory 21, processor power 22, and a communication interface 23 for the connection to the network 104. The operating system 2 runs on the hardware platform 3. Running directly on the operating system 3 is the management environment 4, with a hypervisor 46, which starts the three sandboxes 41, 42, and 43 in virtual machines 81, 82, and 83. In each virtual machine 81, 82, or 83, an execution environment 51, 52, or 53 runs, respectively. In each execution environment 51, 52, or 53, an instance 61, 62, or 63 of the control software can be run, respectively.

From the virtual machines 81, 82, or 83, access to the operating system 3 and the hardware resources 21, 22, and 23, respectively, is only possible via the hypervisor 46. This access is regulated via the resource manager 44. The resource manager 44 is particularly designed to completely or partially revoke the resources 21, 22, or 23 according to rules 47a, 47b, and 47c from one of the virtual machines 81, 82, or 83 when there is a shortage of resources 21, 22, or 23, in order to provide them to another virtual machine 81, 82, or 83 which needs them more urgently. To this end, the rules 47a, 47b, and 47c are sorted in the set of rules 47 according to the seriousness of the respective effect of the revocation of the resources on the industrial facility 100 as a whole. The performance of the industrial facility 100 thus drops to an acceptable level in the case of a resource shortage, instead of the futile attempt being made to maintain full operation.

The instances 61, 62, and 63 of the control software are additionally controlled via the redundancy manager 45 to the effect that they redundantly provide the functionality of the PLC 1 with respect to the field device 101. This further feature is implemented solely in the redundancy manager 45. The execution environments 51, 52, and 53, as well as the instances 61, 62, and 63, are unchanged with respect to a PLC 1, without management system 4.

The management system 4 can thus also be retrofitted on a PLC 1, in which the execution environment 51, 52, or 53, and/or the control software 61, 62, or 63, is only present as compiled binary code.

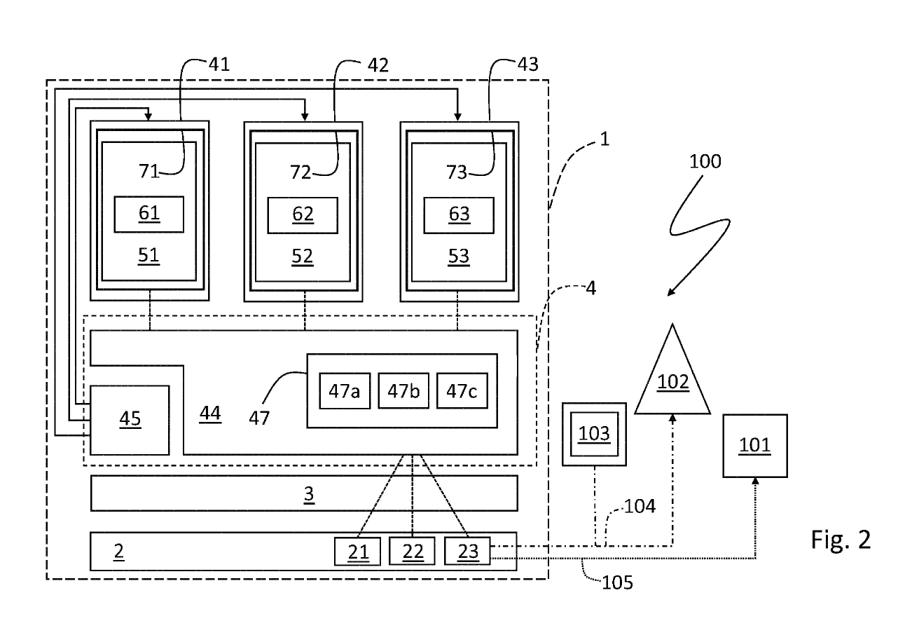

FIG. 2 shows the same industrial facility 100 as FIG. 1, but with a PLC 1 according to another exemplary embodiment of the invention. In contrast to FIG. 1, the sandboxes 41, 42, and 43 are not designed as virtual machines. Instead, the execution environments 51, 52, and 53, mediated by abstraction layers 71, 72, or 73, respectively, run as normal processes on the operating system 3. The abstraction layers 71, 72, or 73 each represent a runtime environment for the system calls originating from the execution environments 51, 52, or 53, respectively.

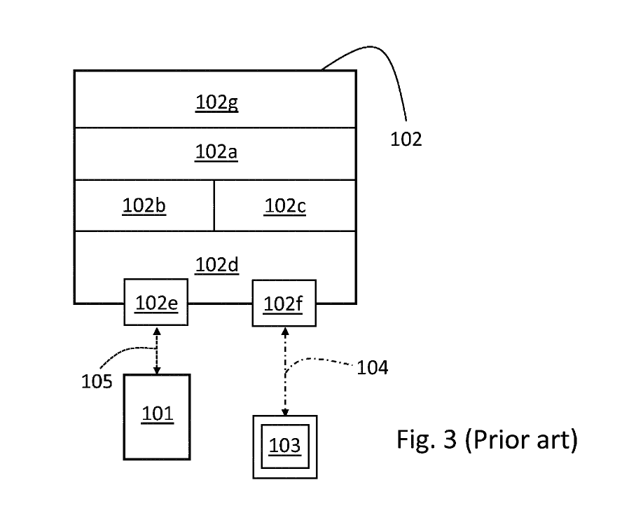

In comparison, FIG. 3 shows the structure of the PLC 102 according to the prior art and the connection of this PLC 102 to the field device 101 and to the network 104. The control software 102g runs on an execution environment 102a, which in turn runs on an operating system 102b and uses proprietary hardware drivers 102c. The operating system 102b and the hardware drivers 102c access the proprietary hardware 102d, which comprises a first interface 102e, for the communication with the field device 101 via the I/O interface 105, and a second interface 102f for the connection to the network 104.

In contrast to FIGS. 1 and 2, the various components of the PLC 102 build on one another and interact, but are not abstracted from one another and encapsulated. Any change in the hardware 102d necessitates a change in the hardware drivers 102c. Changing the hardware 102d to a new hardware architecture, at the latest, also necessitates changes to the operating system 102b. The modified hardware drivers 102c make it necessary to adapt the control software 102g that accesses these hardware drivers 102c. A change of the operating system 102b due to the change of the hardware architecture involves further changes to the control software 102g and the execution environment 102a on which this control software 102g runs.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Numbers

1 Programmable logic controller, PLC
2 Hardware platform of the PLC 1
21 Main memory of the hardware platform 2
22 Processor power of the hardware platform 2
23 Communication resources of the hardware platform 2
3 Operating system of the PLC 1
4 Management system of the PLC 1
41-43 Sandboxes for execution environments 51-53
44 Resource manager in the management system 4
45 Redundancy manager in the management system 4
46 Hypervisor for virtual machines 81-83
47 Set of rules for reallocation of resources 21-23
47a-47c Rules
51-53 Execution environments for control software 61-63
51′-53′ Environments 51-53 adapted for paravirtualization
61-63 Control software
61′-63′ Control software 61-63 adapted for paravirtualization
71-73 Abstraction layers in sandboxes 41-43
71′-73′ Abstraction layers 71-73 adapted for paravirtualization
81-83 Virtual machines as sandboxes 41-43
100 Industrial facility
101 Field device in industrial facility 100
102 PLC according to the prior art
102a Execution environment of PLC 102 for software 102g
102b Operating system of the PLC 102
102c Proprietary hardware drivers of the PLC 102
102d Proprietary hardware of the PLC 102
102e Interface of the PLC 102 for I/O interface 105
102f Interface of the PLC 102 to network 104
102g Control software of the PLC 102
103 Human-machine interface of industrial facility 100
104 Network of the industrial facility 100
105 I/O interface

What is claimed is:

1. A programmable logic controller for at least one field device in an industrial facility, comprising:
a hardware platform on which an operating system runs, the operating system being configured to execute, in at least one process, at least one execution environment in which a control software containing the control logic of the programmable logic controller is runnable, the hardware platform comprising a main memory, a processor power, and communication resources; and
a higher-level management system configured to run directly on the operating system and to execute one or more execution environments in each case in its own sandbox, the management system comprising a resource manager configured to allocate to each sandbox access to the main memory, the processor power, and the communication resources of the hardware platform.

2. The programmable logic controller according to claim 1, wherein the management system comprises a redundancy manager configured to retrieve and provide a functionality of the controller, provided in relation to the field device, from multiple redundant instances of the control software.

3. The programmable logic controller according to claim 2, wherein the redundancy manager is configured to forward data inputs from the field device to multiple instances of the control software and to make data outputs subsequently generated by these instances plausible with respect to each other.

4. The programmable logic controller according to claim 2, wherein the redundancy manager is configured to continuously monitor a functioning of multiple instances of the control software and, when an instance fails, to restart this instance and/or its execution environment, and/or to activate at least one additional instance in an additional execution environment in a further sandbox.

5. The programmable logic controller according to claim 2, wherein the redundancy manager is configured to control a communication of multiple instances of the control software with the field device according to a round robin method.

6. The programmable logic controller according to claim 1, wherein two execution environments having different contents and/or two instances of the control software having different contents are provided to afford a functionality of the controller.

7. The programmable logic controller according to claim 1, wherein at least one sandbox contains an abstraction layer configured to react to system calls originating from the execution environment in a same way as the operating system and/or the hardware of a control unit for which the execution environment and/or the associated control software was developed.

8. The programmable logic controller according to claim 7, wherein the abstraction layer contains at least one runtime environment configured to implement handling routines for the system calls originating from the execution environment, using the operating system.

9. The programmable logic controller according to claim 1, wherein the management system is configured to generate a separate user space instance with virtualization functions of the operating system for each sandbox.

10. The programmable logic controller according to claim 1, wherein the management system contains a hypervisor configured to provide a separate virtual machine for each sandbox.

11. The programmable logic controller according to claim 10, wherein at least one version, adapted to the hypervisor, of an execution environment and/or at least one version, adapted to the hypervisor, of the abstraction layer is paravirtualized by the hypervisor.

12. The programmable logic controller according to claim 1, wherein the resource manager is configured to reallocate allocations unused in at least one first sandbox for access to the main memory, processor power, and/or communication resources to at least one second sandbox.

13. The programmable logic controller according to claim 1, wherein the resource manager is configured to completely or partially revoke a respective resource of at least one first sandbox and to reallocate it to at least one second sandbox according to rules in a set of rules when there is a shortage of main memory, processor power, and/or communication resources.

14. The programmable logic controller according to claim 13, wherein the rules in the set of rules are staggered according to effects of a respective revocation of resources on the industrial facility as a whole.

15. A computer program product containing machine-readable instructions, which, if executed on a computer and/or a programmable logic controller, upgrade the computer or programmable logic controller to the programmable logic controller according to claim 1.
